(19) United States
(12) Patent Application Publication
(10) Pub. No.: US 2003/0216893 A1
(43) Pub. Date: Nov. 20, 2003

(54) Method of designing and constructing a power plant

(76) Inventor: Warren Hendrickson, San Jose, CA (US)

Correspondence Address: Valley Oak Law, 5655 Silver Creek Valley Road, #106, San Jose, CA, 95138, US

(21) Appl. No.: 10/150,271

(22) Filed: May 17, 2002

(51) Int. Cl. G06F 17/50

(52) U.S. Cl. 703/1

(57) ABSTRACT

A method of planning and building a power plant are described. A method of building a power plant comprising positioning a first power plant module within the power plant via roll transfer technology wherein the first power plant module is encased within a first shipping structure; positioning a second power plant module within the power plant adjacent to the first power plant module via roll transfer technology wherein the second power plant module is encased within a second shipping structure; and electrically coupling the first power plant module with the second power plant module with a quick connector connection. A method of designing a power plant comprising determining an amount of power needed from the power plant; calculating a plurality of power generator modules needed to generate the amount of power; and symmetrically configuring the plurality of power generator modules within the power plant.

### FIELD OF THE INVENTION

The invention relates generally to the field of power plants, and more particularly the design, configuration, construction, and maintenance of power plants.

### BACKGROUND OF THE INVENTION

The proliferation of the use of electricity around the world has increased in the past years. The use of power plants to generate electricity has also increased world-wide. There is a need to construct more power plants which are closer to the consumer of electric power. By achieving a more distributed electric power generation system, power distribution delays and bottlenecks can be alleviated and avoided. However, designing and constructing a power plant has traditionally been costly and time consuming.

There have also been many innovations relating to prefabrication of power plant segments thereby aiding in the construction of power plants. However, there is always a need for power plants which are easier to design and construct. The benefits of power plants which are easier to design and construct include a more reliable power plant with less down-time, more consistently designed power plant which can be duplicated, decreased construction costs, and faster construction period.

As the demand and dependency on electricity has grown, the reliability of electric power generation becomes more important. Improvements to reliability may be achieved through refinements in the design of electric power plants. One benefit of increased reliability is less costly maintenance and less wasted downtime.

The increase in the number of electric power plants world-wide underscores the importance of improvements in the design and construction of power plants.

### SUMMARY OF THE INVENTION

A method of planning and building a power plant are described. A method of building a power plant comprising positioning a first power plant module within the power plant via roll transfer technology wherein the first power plant module is encased within a first shipping structure; positioning a second power plant module within the power plant adjacent to the first power plant module via roll transfer technology wherein the second power plant module is encased within a second shipping structure; and electrically coupling the first power plant module with the second power plant module with a quick connector connection. A method of designing a power plant comprising determining an amount of power needed from the power plant; calculating a plurality of power generator modules needed to generate the amount of power; and symmetrically configuring the plurality of power generator modules within the power plant.

### BRIEF DESCRIPTION OF THE DRAWINGS

For a better understanding of the present invention, together with other and further advantages and features thereof, reference is had to the following description taken in connection with the accompanying drawings in which:

FIG. 1 illustrates a simplified block diagram of a power plant layout in accordance with one embodiment of the invention.

FIG. 2 illustrates a block diagram of a power plant layout in accordance with one embodiment of the invention.

FIG. 3 illustrates an exemplary direct converter in accordance with one embodiment of the invention.

FIG. 4 illustrates an exemplary superconducting magnet in accordance with one embodiment of the invention.

FIGS. 5A, 5B, 5C, and 5D illustrate an exemplary process of assembling modules of a power plant by use of roll transfer in accordance with one embodiment of the invention.

FIG. 6 illustrates an exemplary process of manufacturing a converter module in accordance with one embodiment the invention.

FIG. 7 illustrates an exemplary routing scheme in accordance with one embodiment of the invention.

FIG. 8 is a flow diagram illustrating the modular nature of configuring a power plant to meet the current and future power demands

FIG. 9 is a flow diagram illustrating general design and construction principles of a power plant.

FIG. 10 is a flow diagram illustrating one embodiment of positioning a power plant module within a power plant.

### DETAILED DESCRIPTION OF THE EMBODIMENTS

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

The invention describes both off-site pre-fabrication and on-site installation of electric power plants. The invention further describes a standardized system and method for building electric power plants. By standardizing the electric power plant assembly, power plant construction design and assembly times are reduced, damaged parts are minimized, operating personnel are minimized, and mean time between failure is maximized.

The method of power plant prefabrication and installation illustrate the power plant being divided into modules. These modules are designed to be prefabricated within finite packaging limitations. These finite packaging limitations allow the modules to be shipped fully assembled while minimizing shipping costs.

In one embodiment, the prefabrication of the modules occurs off-site at a factory production facility. Further, by dividing the power plant components into modules, the design and implementation of the power plant output capacity is scalable and is based upon the number of power generating modules, the size of the power plant facility, and the interface to the power grid.

In one embodiment, the invention is optimized for a plasma electricity generation power plant. However in other embodiments, other types of fuel may be utilized by the power plant such as diesel, natural gas, oil, nuclear and the like.

To efficiently maintain and operate a power plant, the invention utilizes multiple independent power units in one embodiment. Additionally, each independent power unit utilizes multiple power modules.

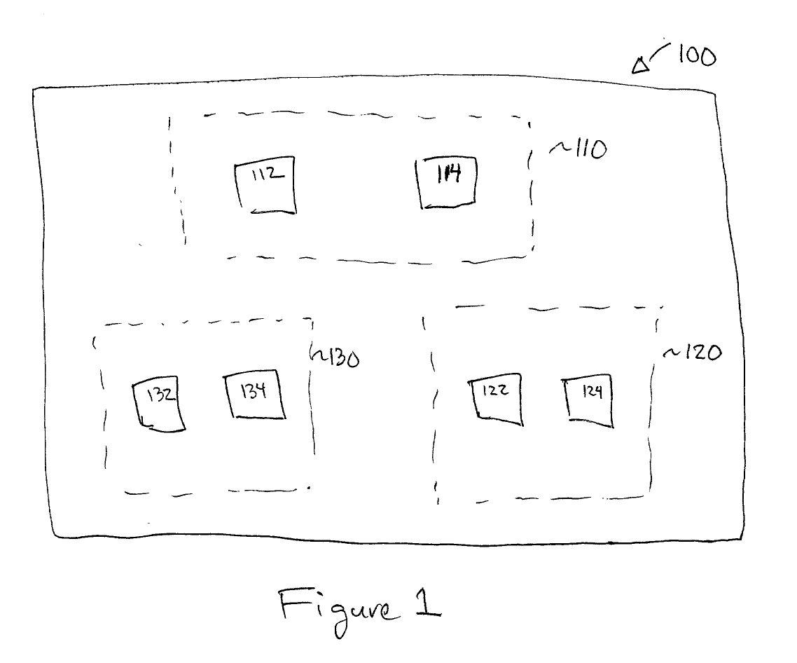

FIG. 1 illustrates one embodiment of a power unit and power module layout. In other embodiments, various configurations may be utilized.

In one embodiment, a power plant 100 has a capacity of 300 Mwe. In this embodiment, the power plant 100 utilizes three separate independent 100 Mwe units 110, 120, and 130. In one embodiment, each of the independent 100 Mwe units utilizes a two separate 50 Mwe module. For example, the independent unit 110 utilizes separate 50 Mwe modules 112 and 114. Similarly, the independent unit 120 utilizes separate 50 Mwe modules 122 and 124. Similarly, the independent unit 130 utilizes separate 50 Mwe modules 132 and 134. By creating multiple power modules such as modules 112, 114, 122, 124, 132, and 134, the power plant 100 may continue producing power while individual modules are shut down for routine maintenance or in the event of a failure in a particular module.

In other embodiments, each of the units 110, 120. and 130 may have an infinite capacity to produce power. Similarly, in other embodiments, the modules 112, 114, 122, 124, 132, and 134 may have an infinite capacity to produce power.

In one embodiment, a helium cooling system is utilized to cool the modules 112, 114, 122, 124, 132, and 134. The helium system is capable of allowing one module to warm up for service while still cooling the remaining modules. Helium refrigeration compressors have an extended expected mean time between failure. In other embodiments, various other cooling systems may be utilized.

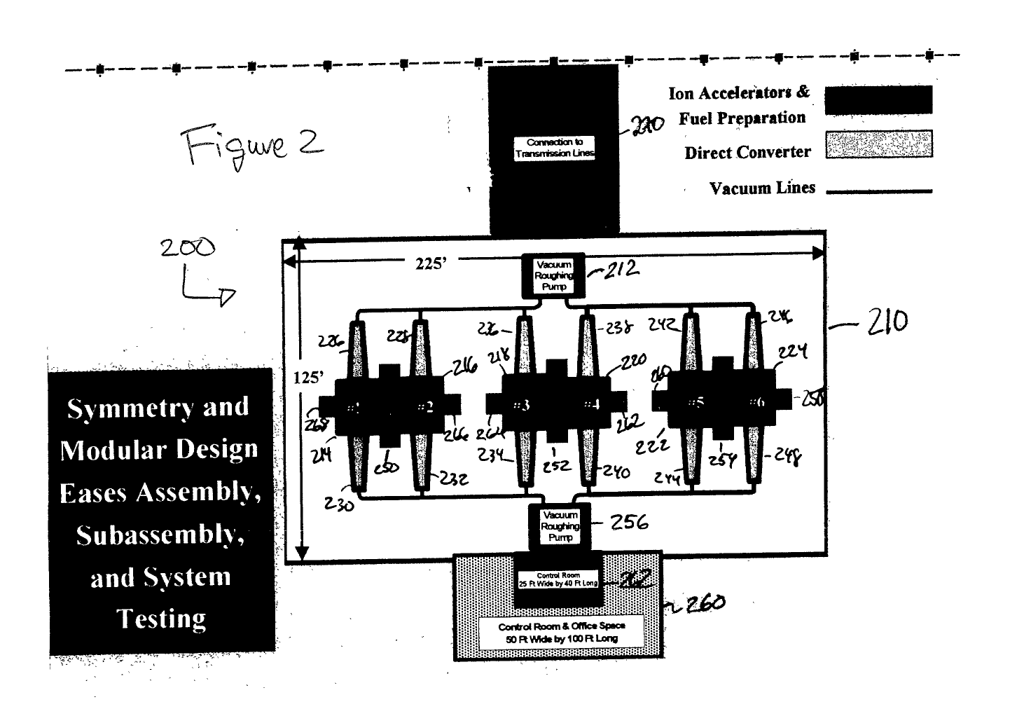

FIG. 2 illustrates one embodiment of a simplified block diagram of a power plant 200. The power plant 200 includes a power generation block 210, a control room block 260, and a connection to transmission lines block 270. In one embodiment, the power generation block 210 includes vacuum pump modules 212 and 256; superconducting magnet modules 214, 216, 218, 220, 222, and 224; direct converter modules 226, 228, 230, 232, 234, 236, 238, 240, 242, 244, 246, and 248; ion accelerator and fuel preparation modules 258, 260, 262, 264, 266, and 268; and helium refrigerator modules 250, 252, and 254.

The superconducting magnet module 214 is coupled to the direct converter modules 226 and 230, the ion accelerator and fuel preparation module 268, and the helium refrigeration module 250. The superconducting magnet module 216 is coupled to the direct converter modules 228 and 232, the ion accelerator and fuel preparation module 266, and the helium refrigeration module 250. The superconducting magnet module 218 is coupled to the direct converter modules 234 and 236, the ion accelerator and fuel preparation module 264, and the helium refrigeration module 252. The superconducting magnet module 220 is coupled to the direct converter modules 238 and 240, the ion accelerator and fuel preparation module 262, and the helium refrigeration module 252. The superconducting magnet module 222 is coupled to the direct converter modules 242 and 244, the ion accelerator and fuel preparation module 260, and the helium refrigeration module 254. The superconducting magnet module 224 is coupled to the direct converter modules 246 and 248, the ion accelerator and fuel preparation module 258, and the helium refrigeration module 254.

In another embodiment, the helium refrigerator modules 250, 252, and 254 may be a different type of refrigeration unit.

The direct converter modules 226, 228, 236, 238, 242, and 246 are coupled to the vacuum roughing pump 212 via vacuum lines. The direct converter modules 230, 232, 234, 240, 244, and 248 are coupled to the vacuum roughing pump 212 via vacuum lines.

In one embodiment, each of the modules is sized to fit within a shipping container. The shipping container is dimensioned to be able to be shipped as freight on trains, ships, and trucks. In another embodiment, the shipping container forms a structure for the particular module when constructing the power plant 200. In one embodiment, the container is utilized to form the structure of the power plant 200. In another embodiment, a portion of the container is utilized to form the structure of the power plant 200.

The power generation block 210 is preferably 125 feet by 225 feet. In other embodiments, the power generation block 210 has various dimensions. In one embodiment, the design of the modules within the power generation block 210 are symmetric. The symmetrical design may aid with maintenance and ongoing power production.

In one embodiment, the power plant 200 has a capacity of 300 Mwe. However in other embodiments, the power plant 200 can be scaled from 50 Mwe to over 500 Mwe. In one embodiment, the power plant 200 utilizes multiple power generation blocks. In one embodiment, the power plant 200 utilizes power generation blocks which have varying power generation capabilities by adding or deleting modules within the power generation block.

The control room 262 and office space 260 preferably is 50 feet by 100 feet. A control room 262 is contained within and preferably measures 25 feet by 40 feet. In other embodiments, different dimensions are utilized for the control room 262 and the office space 260.

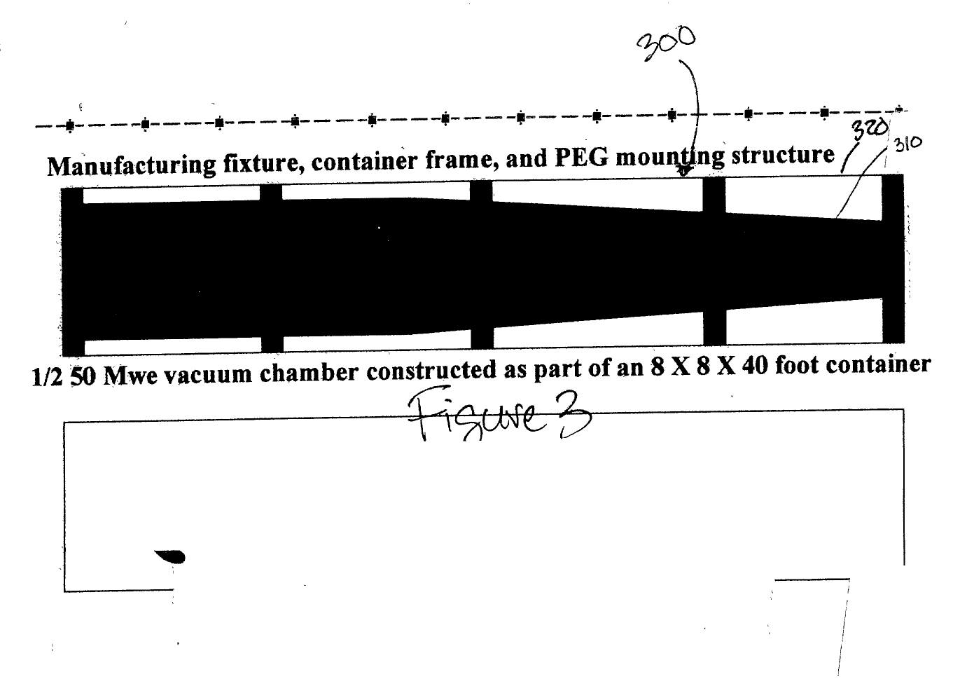

FIG. 3 illustrates an exemplary direct converter 300 in one embodiment. The direct converter 300 includes a vacuum chamber 310 which is configured to be housed within a structure 320. In one embodiment, the structure 320 has a dimension of 8 feet by 8 feet by 40 feet. In another embodiment, the structure 320 may have different dimensions. In yet another embodiment, the structure 320 is constructed as part of a shipping container.

In addition, the structure 320 includes mounting brackets for use during shipping and fixed operation. In one embodiment, the structure 320 is capable of housing the vacuum chamber 310 during shipping, construction, and operation of a power plant.

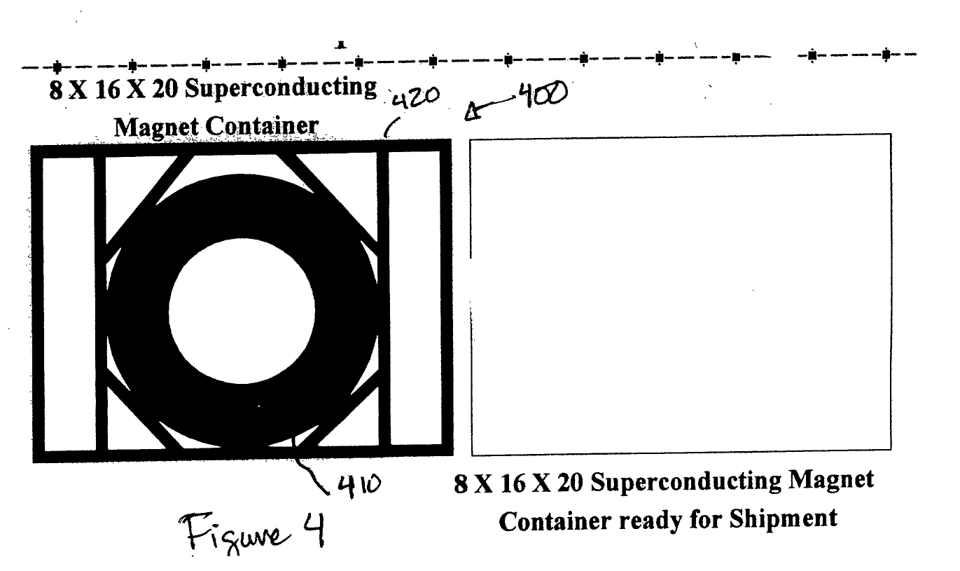

FIG. 4 illustrates an exemplary superconducting magnet 400. The superconducting magnet 400 includes a magnet 410 which is configured to be housed within a structure 420. The structure 420 preferably has a dimension of 8 feet by 16 feet by 20 feet. The structure 420 preferably is constructed as part of a shipping container. In addition, the structure 420 includes mounting brackets for use during shipping and fixed operation. The structure 420 is capable of housing the magnet 410 during shipping, construction, and operation of a power plant. In other embodiments, the structure 420 may have various other dimensions.

In one embodiment, the invention utilizes roll transfer technology to construct modular portions of the power plant such as the superconducting magnets, the direct converters, and the like in building power plants. By using roll transfer technology, lifting individual modules during construction is minimized. Transporting power plant modules by primarily sliding the modules horizontally as opposed to vertically lifting the modules is one principle behind the roll transfer technology. By minimizing vertically lifting power plant modules, the risk damaging individual modules is minimized. In one embodiment, if vertical lifting occurs, it is kept to a minimum in order to move the power plant module from one surface to another surface. However, the vertical lifting is not utilized for the purpose of transporting the power plant module over horizontal distances. Further, costly cranes or other lifting means are not needed thus decreasing the cost and time line of building power plants. Roll transfer technology may be applied to the power plant modules with rails, air pallets, ball bearings, and/or anti-friction materials.

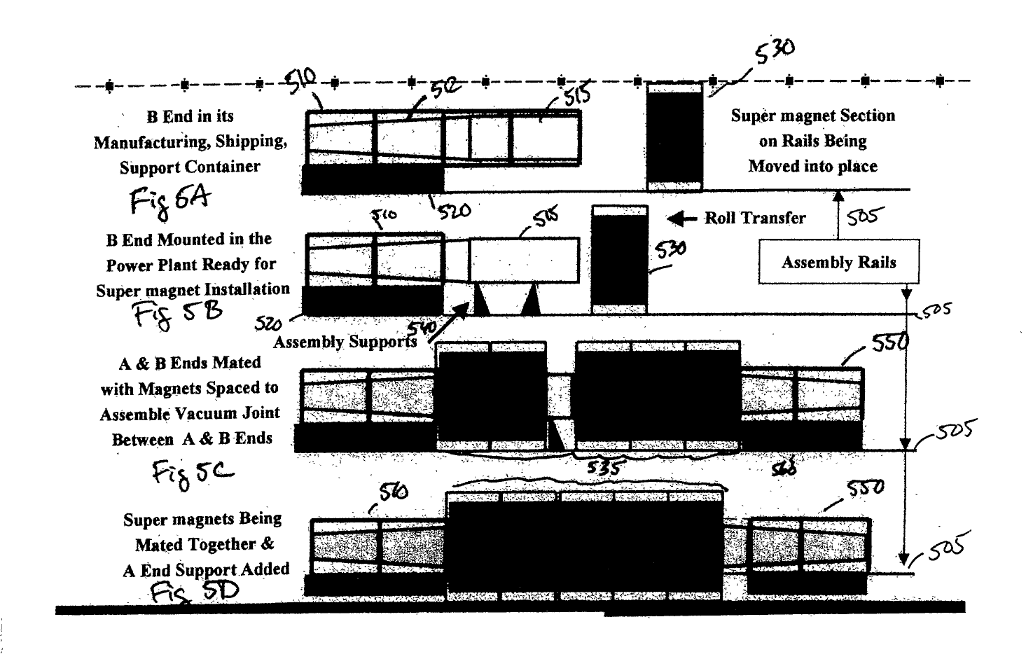

FIGS. 5A, 5B, 5C, and 5D illustrate a process in one embodiment of assembling modules of a power plant by use of roll transfer instead of lifting. FIGS. 5A, 5B, 5C, and 5D are shown for exemplary purposes only and are not to be construed as limiting the scope of the invention.

FIG. 5A illustrates a converter module 510 being slided onto a platform 520 along a rail 505. The converter module 510 includes a direct converter 512 and a plasma converter 515. A superconducting magnet 530 is rolled along the rail 505 into position to couple with the converter module 510.

FIG. 5B illustrates a portion of the container over the converter module 510 being removed and supports 540 under the plasma converter 515 being placed.

FIG. 5C illustrates a plurality of superconducting magnets 535 being rolled along the rail 505 into position surrounding the plasma converter 515. Further, another converter module 550 is rolled along the rail 505 towards the converter module 510 with the plurality of superconducting magnets 535 located between the converter module 510 and the converter module 550.

FIG. 5D illustrates the converter module 510 being coupled with the converter module 550 with the plurality of superconducting magnets 535 located between the converter modules 510 and 550.

The rail 505 is utilized as one embodiment of roll transfer technology according to FIGS. 5A, 5B, 5C, and 5D. In other embodiments, different roll transfer technology may be utilized.

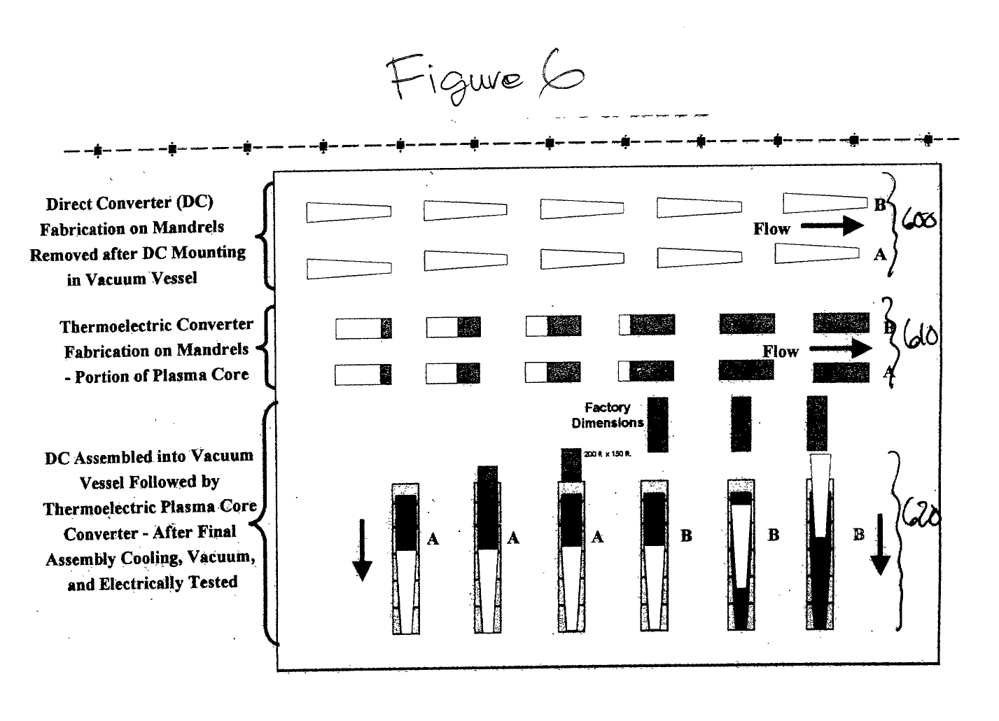

FIG. 6 illustrates a process of manufacturing a converter module. In step 600, the direct converters are manufactured and are positioned ready to transfer and load onto a structure without lifting. The direct converters are transferred by utilizing roll transfer technology as previously described. In step 610, the plasma converters are manufactured and are positioned ready to transfer and load onto a structure without lifting. The plasma converters are transferred by utilizing roll transfer technology as previously described. In step 620, the direct converters are loaded within the structure first followed by the plasma converters without lifting either the direct converters or the plasma converters. Similarly, the direct converters and plasma converters are transferred by utilizing roll transfer technology as previously described.

Another aspect of power plant design, building, and operating is routing of control and power conductor cabling. In a preferred embodiment, the invention routes the control and power conductor cabling through sealed conduits without pigtails. Further, the control and power conductor cabling are mounted at an appropriate height for servicing and maintenance. Additionally, the cabling is routed through the converter modules and superconducting magnetic modules.

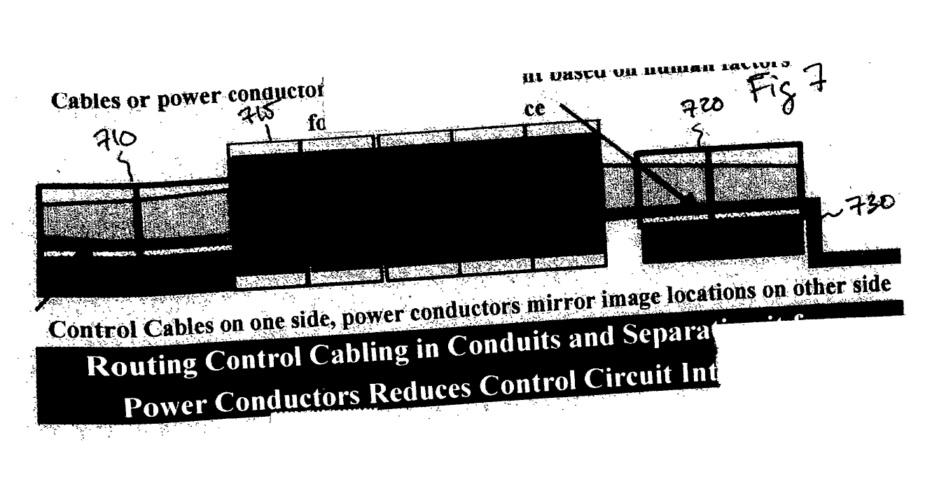

FIG. 7 illustrates a wire routing scheme. A superconducting magnetic module 715 is electrically coupled between a converter module 710 and a converter module 720. A power conductor cabling 730 is routed through the structure of the superconductor magnetic module 715 and the converter modules 710 and 720. Preferably the height of the power conductor cabling 730 is approximately 3 feet high. Also, after the converter modules 710 and 720, the power conductor cabling 730 is routed in the floor to prevent breakage. Although not shown in FIG. 7, the control cabling is preferably run on the opposite side of the superconductor magnetic module 715 and the converter modules 710 and 720. In other embodiments, the power conductor cabling 730 may contain the control cabling as well. In another embodiment, the power conductor cabling 730 may be mounted at any height.

Prior to electrically coupling the superconductor magnetic module 715 with the converter modules 710 and 720, the power conductor cabling 730 was separately found routed through the superconductor magnetic module 715 and the converter modules 710 and 720. In one embodiment, the superconductor magnetic module 715 and the converter modules 710 and 720 were configured to utilize a quick connector connection to electrically couple the superconductor magnetic module 715 with the converter modules 710 and 720. The quick connector connection allows an electrically connection between superconductor magnetic module 715 and the converter modules 710 and 720 through the power conductor cabling 730 by aligning the superconductor magnetic module 715 and the converter modules 710 and 720. The quick connector connection allows quick electrical connections through the power conductor cabling 730 without tedious wire customization or manual wire connections.

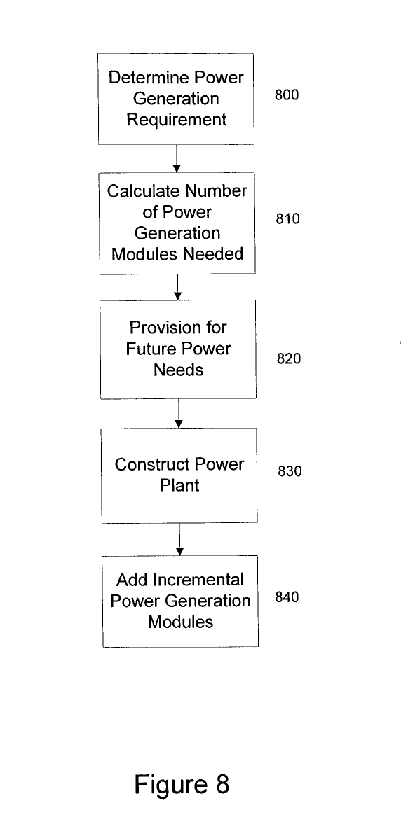

The flow diagrams as depicted in FIGS. 8, 9, and 10 are merely one embodiment of the invention. Each functional block may be performed in a different sequence without departing from the spirit of the invention. Further, blocks may be deleted, added or combined without departing from the spirit of the invention.

FIG. 8 is a flow diagram illustrating the modular nature of configuring a power plant to meet the current and future power demands. In Block 800, a desired amount of power is determined during the planning process of the power plant. In Block 810, a number of power generation modules needed for the power plant is determined. The number of power generation modules depends on the amount of power rated for each power generation module and the desired amount of power needed from the power plant. In Block 820, a space provision is planned for future additional power generation required of the power plant. The power plant is constructed in Block 830. In Block 840, additional power generation modules are added to the power plant due to an increased power demand from the power plant.

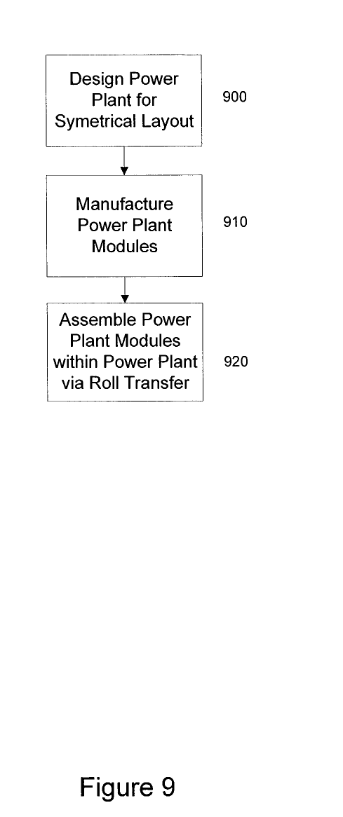

FIG. 9 is a flow diagram illustrating general design and construction principles of a power plant. In Block 900, the power plant is designed with a symmetrical layout with respect to the power generation blocks, converter modules, vacuum pumps, and the like. The symmetrical layout of the modules within the power plant increases layout efficiency from the perspective of designing multiple power plants, fabrication of the power plant modules, and efficiency in servicing the power plant. In Block 910, individual power plant modules are manufactured either on-site or off site. In Block 920, the power plant modules are configured within the power plant and placed into position via roll transfer technology. As described previously, roll transfer technology may include any means of rolling, sliding, and/or transporting that does not require lifting the item. For example, roll transfer may include transporting an item via tracks, rails, ball bearings, air pallets, and the like.

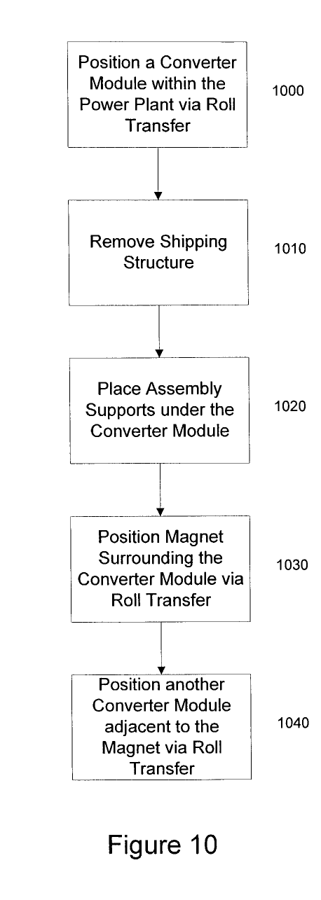

FIG. 10 is a flow diagram illustrating one embodiment of positioning a power plant module within a power plant. In Block 1000, a converter module is positioned within the power plant via roll transfer technology. In Block 1010, the shipping structure surrounding the converter module is partially removed. In Block 1020, supports are placed under the portion of the converter module without the shipping structure. In Block 1030, a magnet module is positioned to surround a portion of the converter module via roll transfer technology. In Block 1040, another converter module is positioned adjacent to the magnet via roll transfer technology.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of building a power plant comprising:
a. positioning a first power plant module within the power plant via roll transfer technology wherein the first power plant module is encased within a first shipping structure;
b. positioning a second power plant module within the power plant adjacent to the first power plant module via roll transfer technology wherein the second power plant module is encased within a second shipping structure;
c. electrically coupling the first power plant module with the second power plant module with a quick connector connection.

2. The method according to claim 1 further comprising loading the first power plant module and the second power plant module into the power plant via roll transfer technology.

3. The method according to claim 1 further comprising removing a portion of the first shipping structure from the first power plant module.

4. The method according to claim 3 further comprising placing a support structure in the portion of the first shipping structure for supporting the first power plant module.

5. The method according to claim 1 wherein the first power plant module is a converter.

6. The method according to claim 1 wherein the second power plant module is a magnet.

7. A method of designing a power plant comprising:
a. determining an amount of power needed from the power plant;
b. calculating a plurality of power generator modules needed to generate the amount of power;
c. symmetrically configuring the plurality of power generator modules within the power plant.

8. The method according to claim 7 further comprising reserving a portion of the power plant for an additional power generator module.

9. The method according to claim 7 further comprising adding an additional power generator module to the power plant.

10. The method according to claim 9 further comprising positioning the additional power generator module within the power plant via roll transfer technology.

11. The method according to claim 7 further comprising servicing one of the plurality of power generator modules while one of the plurality of power generator modules is operating.

12. The method according to claim 7 further comprising scaling an amount of power generated by the power plant by selectively operating each of the plurality of power generator modules.

13. A method of building a power plant comprising:
a. receiving a plurality of power plant modules within the power plant via roll transfer technology;
b. positioning the plurality of power plant modules according to a configuration plan within the power plant via roll transfer technology;
c. electrically coupling one of the plurality of power plant modules with another one of the plurality of power plant modules via a quick connector connection.

14. The method according to claim 13 wherein one of the plurality of power plant modules is received within the power plant in a shipping container.

15. The method according to claim 13 wherein the configuration plan configures the plurality of power plant modules in a symmetrical pattern.

16. The method according to claim 13 further comprising assembling the plurality of power plant modules via roll transfer technology.

17. The method according to claim 13 wherein the roll transfer technology includes transporting one of the plurality of power plant modules by sliding one of the plurality of power plant modules and minimizing lifting one of the plurality of power plant modules.

18. The method according to claim 17 wherein the roll transfer technology includes transporting one of the plurality of power plant modules by using one of rails, ball bearings, air pallets, and anti-friction materials.
